(19) United States
(12) Patent Application Publication
(10) Pub. No.: US 2015/0284250 A1
(43) Pub. Date: Oct. 8, 2015

(54) PLANT FOR PRODUCING TRISILYLAMINE IN THE GAS PHASE

(71) Applicants: Jens DOERING, Dortmund (DE); Hartwig RAULEDER, Rheinfelden (DE); Ingrid LUNT-RIEG, Bad Homburg (DE); Wilfried UHLICH, Marl (DE); Udo KNIPPENBERG, Marl (DE)

(72) Inventors: Jens DOERING, Dortmund (DE); Hartwig RAULEDER, Rheinfelden (DE); Ingrid LUNT-RIEG, Bad Homburg (DE); Wilfried UHLICH, Marl (DE); Udo KNIPPENBERG, Marl (DE)

(73) Assignee: Evonik Degussa GmbH, Essen (DE)

(21) Appl. No.: 14/744,208

(22) Filed: Jun. 19, 2015

Related U.S. Application Data
(62) Division of application No. 14/117,925, filed on Nov. 15, 2013.

(30) Foreign Application Priority Data
May 17, 2011 (DE) 10 2011 075 974.3

(51) Int. Cl. C01B 21/087; B01J 19/24

(52) U.S. Cl. CPC C01B 21/087; B01J 19/24; B01J 19/245; B01J 2219/0004; B01J 2219/24; B01J 2219/00051

(57) ABSTRACT

A plant for preparing trisilylamine in the gas phase is provided. The plant includes a reactor (1) suitable for the reaction of at least the starting materials ammonia and monohalosilane in the gas phase; a precipitation vessel (2) downstream of the reactor (1); and a mixer (3) suitable for producing a homogeneous gas mixture containing at least the starting materials ammonia and monohalosilane upstream of the reactor (1). The mixer (3), reactor (1) and precipitation vessel (2) are connected to one another structurally in such a way that a continuous gas flow through the plant is ensured, with the gas flow optionally being able to be interrupted at one or more suitable points within the plant.

### CROSS REFERENCE TO RELATED APPLICATIONS

This application is a divisional application of prior U.S. application Ser. No. 14/117,925, filed Nov. 15, 2013, the disclosure of which is incorporated herein by reference in its entirety. The parent application is the National stage of PCT/EP2012/57634, filed Apr. 26, 2012, the disclosure of which is incorporated herein by reference in its entirety. The parent application claims priority to German Application No. 102011075974.3, filed May 17, 2011, the disclosure of which is incorporated herein by reference in its entirety.

### BACKGROUND OF THE INVENTION

The present invention relates to a process for preparing trisilylamine from ammonia and monochlorosilane in the gas phase. The present invention further relates to a plant in which such a process can be carried out.

Trisilylamine (TSA), N(SiH₃)₃, is a mobile, colourless, spontaneously flammable and easily hydrolysable liquid having a melting point of −105.6° C. and a boiling point of +52° C. Nitrogen-containing silicon compounds such as trisilylamine are important substances in the semiconductor industry. Here, they are used in chip production as layer precursors for silicon nitride or silicon oxynitride layers, for example. Owing to its use in chip production, it is important to be able to prepare trisilylamine safely, without malfunctions and constantly in the required, generally high-purity quality.

Trisilylamine can be prepared from ammonia and monochlorosilane according to the equation (1): 3 H₃SiCl+4NH₃→N(SiH₃)₃+3NH₄Cl. A by-product of the reaction is ammonium chloride. The reaction of monochlorosilane and ammonia is a spontaneous, exothermic reaction.

In Ber. Dtsch. Chem. Ges. 54, 740 ff., 1921, Alfred Stock and Karl Somieski describe the immediate reaction of monochlorosilane gas and ammonia gas at room temperature according to equation (1). The reaction proceeds in the presence of excess monochlorosilane to form trisilylamine in quantitative yield. Ammonium chloride precipitates as by-product.

WO 2010/141551 A1 describes the reaction of monochlorosilane with ammonia in the gas phase.

In J. Am. Chem. Soc. 88, 37 ff., 1966, Richard L. Wells and Riley Schaeffer describe the reaction of monochlorosilane with ammonia in the liquid phase. Here, monochlorosilane and ammonia are heated from −196° C. to room temperature. Apart from the formation of trisilylamine according to equation (1), subsequent reactions to form trisilylcyclotrisilazane and polymeric material are observed.

It is an object of the present invention to provide an industrial solution to the preparation of trisilylamine from ammonia and monochlorosilane in the gas phase. This object is achieved by the process described below. A plant in which such a process can be carried out is likewise described below.

### SUMMARY OF THE INVENTION

The invention provides, in particular, a process for preparing trisilylamine in the gas phase, in which at least the starting materials ammonia and monohalosilane are fed in each case in gaseous form into a reactor, react there to form a product mixture containing trisilylamine and the product mixture is discharged from the reactor after the reaction, characterized in that the product mixture is discharged as a gaseous mixture from the reactor. The gaseous product mixture typically contains trisilylamine, hydrogen halide and ammonia.

In particular, the process of the invention is characterized in that the product mixture in the reactor is essentially free of solid ammonium halide.

### BRIEF DESCRIPTION OF THE DRAWING

FIG. 1 shows, schematically a plant according to the invention for preparing trisilylamine from ammonia and monochlorosilane in the gas phase.

### DETAILED DESCRIPTION OF THE PREFERRED EMBODIMENTS

In a preferred embodiment of the process of the invention, the temperature of the gas mixture comprising at least the starting materials and/or the product mixture in the reactor is higher than the decomposition temperature of the coproduct of hydrogen halide and ammonia and lower than the decomposition temperature of trisilylamine.

The temperature of the gas mixture in the reactor can be, for example, in the range from 340° C. to 550° C., preferably from 360° C. to 500° C., more preferably from 380° C. to 450° C.

In a preferred embodiment of the process of the invention, an inert gas, preferably nitrogen or argon, is also introduced into the reactor in addition to the introduction of at least the starting materials ammonia and monohalosilane.

The introduction of the gases comprising at least the starting materials ammonia and monohalosilane into the reactor is preferably carried out jointly. Particular preference is given to the gases being mixed in a mixer to form a homogeneous gas mixture before introduction into the reactor. Here, the inert gas can optionally be mixed, preferably homogeneously, into the gas mixture.

In a preferred embodiment of the process of the invention, the gases introduced together are heated to a temperature which is higher than the decomposition temperature of the coproduct of hydrogen halide and ammonia and lower than the decomposition temperature of trisilylamine before introduction. This can prevent solid ammonium halide being formed as by-product of the reaction between the starting materials ammonia and monohalosilane in the mixer or in the feed lines before reaching the reactor.

In a preferred embodiment of the process of the invention, the product mixture discharged from the reactor contains ammonia which together with hydrogen halide is precipitated in solid form as coproduct after discharge from the reactor. The precipitation preferably occurs in a precipitation vessel downstream of the reactor.

In a preferred embodiment of the process of the invention, the coproduct of hydrogen halide and ammonia precipitates in solid form on the surface of the wall of the precipitation vessel which comes into contact with the product mixture. To promote this precipitation, it is advantageous for at least the surface of the wall which comes into contact with the product mixture to have a temperature lower than the decomposition temperature of the coproduct of hydrogen halide and ammonia and a temperature higher than the boiling point of trisilylamine.

In an alternative embodiment of the process of the invention, the coproduct of hydrogen halide and ammonia does not precipitate on the surface of the wall of the precipitation vessel which comes into contact with the product mixture. In this case, it is advantageous for at least the surface of the wall which comes into contact with the product mixture to be heated to a temperature which is at least 200° C. but lower than the decomposition temperature of trisilylamine.

In a preferred embodiment of the process of the invention, the precipitation of the coproduct is brought about by cooling of the product mixture. Cooling can, for example, be effected by mixing an inert gas having a sufficiently low temperature into the product mixture before, during or after introduction into the precipitation vessel. Nitrogen or argon is preferably used as inert gas.

The coproduct which has been precipitated in solid form from the remaining gaseous product mixture is preferably filtered out by means of a filter.

In an alternative embodiment of the process of the invention, the coproduct which has precipitated in solid form can be removed from the remaining gaseous product mixture by means of a cyclone. In this case in particular, preference is given to the flow velocity in the cyclone being increased by additional introduction of an inert gas into the reactor. As an alternative or in addition, the flow velocity in the cyclone can be increased by mixing an inert gas having a sufficiently low temperature into the product mixture before, during or after introduction of the latter into the precipitation vessel. Here too, nitrogen or argon is preferably used as inert gas.

In a preferred embodiment of the process of the invention, the trisilylamine is condensed out from the product mixture. It can subsequently be purified by distillation.

In a variant of the process of the invention, the starting material monohalosilane can be obtained from dihalosilane and monosilane in a preceding synproportionation. Here, the monosilane is preferably used in a stoichiometric excess.

The invention also provides a plant for preparing trisilylamine in the gas phase, which comprises:
a reactor suitable for the reaction of at least the starting materials ammonia and monohalosilane in the gas phase;
a precipitation vessel downstream of the reactor; and
a mixer suitable for producing a homogeneous gas mixture containing at least the starting materials ammonia and monohalosilane upstream of the reactor;
   where mixer, reactor and precipitation vessel are connected to one another structurally in such a way that a continuous gas flow through the plant is ensured, with the gas flow optionally being able to be interrupted at one or more suitable points within the plant.

The above-described plant of the invention can be extended in such a way that the plant additionally comprises one, more than one or all of the following components:
a feed line which is located downstream of the reactor and is suitable for mixing an inert gas into the product mixture discharged from the reactor before, during or after introduction of the product mixture into the precipitation vessel; and/or
a filter which is located downstream of the precipitation vessel and is suitable for filtering out a coproduct which has been precipitated in solid form from the remaining gaseous product mixture or a cyclone which is located downstream of the precipitation vessel and is suitable for removing a coproduct which has been precipitated in solid form from the remaining gaseous product mixture; and/or
a condenser which is located downstream of the filter or the cyclone and is suitable for condensing trisilylamine from the product mixture; and/or
a synproportionation reactor which is located upstream of the reactor and is suitable for preparing the starting material monohalosilane from dihalosilane and monosilane, with the synproportionation reactor preferably being preceded by a second mixer which is suitable for producing a homogeneous gas mixture containing at least the starting materials silane and dihalosilane;
   where mixer, reactor, precipitation vessel and, if present, second mixer, synproportionation reactor, filter, cyclone and condenser are connected to one another structurally in such a way that a continuous gas flow through the plant is ensured, with the gas flow optionally being able to be interrupted at one or more suitable points within the plant.

In a preferred embodiment of the plant of the invention, the reactor can be heated and/or cooled to a temperature which is higher than the decomposition temperature of the coproduct of hydrogen halide and ammonia and lower than the decomposition temperature of trisilylamine.

Preference is likewise given to at least the surface of the wall of the precipitation vessel which comes into contact with the product mixture being able to be heated to a temperature of at least 200° C.

In a variant of the plant of the invention, it is possible to provide a plurality of precipitation vessels which are connected in parallel and can be operated simultaneously or alternately and can be individually taken out of operation for the purposes of removing precipitated coproduct or for the purposes of other maintenance while the remainder of the plant continues to operate.

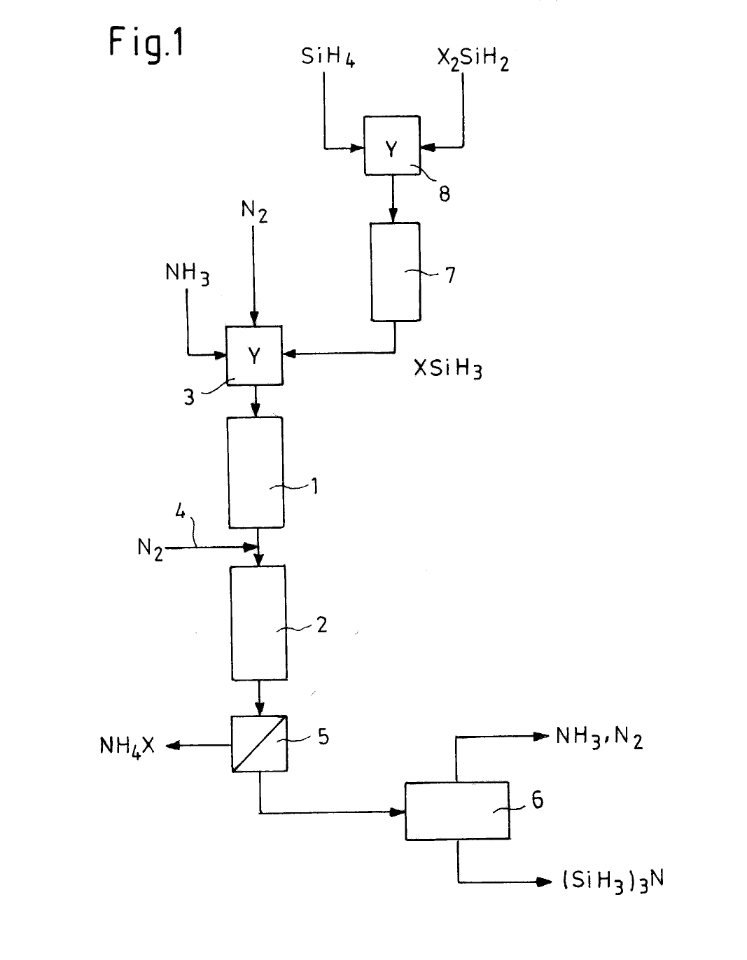

The plant according to the invention shown in FIG. 1 comprises a reactor 1 for the reaction of the starting materials ammonia and monohalosilane in the gas phase, a precipitation vessel 2 downstream of the reactor 1 and a first mixer 3 for producing a homogeneous gas mixture consisting of the starting materials ammonia NH₃ and monohalosilane XSiH₃, where here and in the following X is selected from the group of halogens and X is preferably Cl, and the inert gas nitrogen N₂ located upstream of the reactor 1, with the materials being fed via separate lines to the first mixer 3. The plant further comprises a feed line 4 downstream of the reactor 1 for mixing an inert gas, e.g. nitrogen N₂, into the product mixture discharged from the reactor 1 before the product mixture is introduced into the precipitation vessel 2, a filter 5 downstream of the precipitation vessel 2 for filtering out ammonium halide NH₄X from the remaining gaseous product mixture and a condenser 6 downstream of the filter 5 for condensing out trisilylamine (SiH₃)₃N from the product mixture. The plant further comprises a synproportionation reactor 7 upstream of the reactor 1 for preparing the starting material monohalosilane XSiH₃ from dihalosilane X₂SiH₂ and monosilane SiH₄ and a second mixer 8 upstream of the synproportionation reactor 7 for producing a homogeneous gas mixture containing at least the starting materials silane SiH₄ and dihalosilane X₂SiH₂. The plant further comprises lines 9 which structurally connect the first mixer 3, the reactor 1, the precipitation vessel 2, the second mixer 8, the synproportionation reactor 7, the filter 5 and the condenser 6 to one another in such a way that a continuous gas flow through the plant is ensured. Valves or the like by means of which the gas flow can be interrupted at one or more suitable points within the plant are not shown in FIG. 1.

### LIST OF REFERENCE NUMERALS

(1) reactor
(2) precipitation vessel
(3) first mixer
(4) feed line for inert gas
(5) filter
(6) condenser
(7) synproportionation reactor
(8) second mixer
(9) lines which connect (1), (2), (3), (5), (6), (7) and (8) to one another

1. A plant for preparing trisilylamine in the gas phase, which comprises:
a reactor (1) suitable for the reaction of at least the starting materials ammonia and monohalosilane in the gas phase;
a precipitation vessel (2) downstream of the reactor (1); and
a mixer (3) suitable for producing a homogeneous gas mixture containing at least the starting materials ammonia and monohalosilane upstream of the reactor (1);
where mixer (3), reactor (1) and precipitation vessel (2) are connected to one another structurally in such a way that a continuous gas flow through the plant is ensured, with the gas flow optionally being able to be interrupted at one or more suitable points within the plant.

2. The plant according to claim 1, wherein
the plant additionally comprises one, more than one or all of the following components:
a feed line (4) which is located downstream of the reactor (1) and is suitable for mixing an inert gas into the product mixture discharged from the reactor (1) before, during or after introduction of the product mixture into the precipitation vessel (2); and/or
a filter (5) which is located downstream of the precipitation vessel (2) and is suitable for filtering out a coproduct which has been precipitated in solid form from the remaining gaseous product mixture or a cyclone (5) which is located downstream of the precipitation vessel (2) and is suitable for removing a coproduct which has been precipitated in solid form from the remaining gaseous product mixture; and/or
a condenser (6) which is located downstream of the filter (5) or the cyclone (5) and is suitable for condensing trisilylamine from the product mixture; and/or
a synproportionation reactor (7) which is located upstream of the reactor (1) and is suitable for preparing the starting material monohalosilane from dihalosilane and monosilane, with the synproportionation reactor (7) preferably being preceded by a mixer (8) which is suitable for producing a homogeneous gas mixture containing at least the starting materials silane and dihalosilane;
where mixer (3), reactor (1), precipitation vessel (2) and, if present, mixer (8), synproportionation reactor (7), filter (5), cyclone (5) and condenser (6) are connected to one another structurally in such a way that a continuous gas flow through the plant is ensured, with the gas flow optionally being able to be interrupted at one or more suitable points within the plant.

3. The plant according to claim 1,
wherein
the reactor (1) can be heated and/or cooled to a temperature which is higher than the decomposition temperature of the coproduct of hydrogen halide and ammonia and lower than the decomposition temperature of trisilylamine.

4. The plant according to claim 1,
wherein
at least the surface of the wall of the precipitation vessel (2) which comes into contact with the product mixture can be heated to a temperature of at least 200° C.

5. The plant according to claim 1,
wherein
a plurality of precipitation vessels (2) which are connected in parallel and can be operated simultaneously or alternately and can be individually taken out of operation for the purposes of removing precipitated coproduct or for the purposes of other maintenance while the remainder of the plant continues to operate are provided.
